(19) United States
(12) Patent Application Publication
(10) Pub. No.: US 2026/0195764 A1
(43) Pub. Date: Jul. 9, 2026

(54) System and method using an AI-powered queue resolver during outages

(71) Applicant: Bank of America Corporation, Charlotte, NC (US)

(72) Inventors: Nipun Mahajan, Lawrenceville, NJ (US); Amit Mishra, Chennai (IN); Balaji Sugumar, Chennai (IN); Shubhakar A, Chennai (IN); S.B. Pravin Kumar, Nagercoil (IN)

(21) Appl. No.: 19/015,059

(22) Filed: Jan. 9, 2025

(51) Int. Cl. G06Q 30/01; G06F 40/20

(52) U.S. Cl. CPC G06Q 30/01; G06F 40/20

(57) ABSTRACT

A system is configured to receive a current query from a first device and identify a query type from a plurality of stored query types. It then obtains the information from the first device needed to respond to the current query when a second device that normally processes the query is determined not to function. When obtaining the information, the system executes an algorithm associated with a text generation model to generate prompts to obtain the information required to respond to the current query and send them to the first device. In response, the system receives the information, creates an incident ticket, and stores the information with the incident ticket. When the second device is functioning normally again, it is caused to perform the actions to process the current query, and the incident ticket is closed when all the actions are performed.

### TECHNICAL FIELD

The present disclosure relates generally to network communications and, more specifically, to a system and method using an artificial intelligence (AI) powered queue resolver during outages.

### BACKGROUND

The resources needed to perform many activities may be located on multiple devices connected by a large network, including the Internet. This complexity allows for redundancy and improved capacity. However, when problems occur due to the volume of activities that need to be performed or routed to the appropriate devices or resources, resource requests may be misrouted, delayed, and/or lost.

### SUMMARY

Large organizations may rely on multiple computer systems and resources to respond to queries from external devices and/or users. These queries may come from users or customers of the organization's systems and/or products. When these systems are functioning properly, user queries may be efficiently addressed either through automated means or by forwarding the query to the appropriate personnel, such as, but not limited to, workers at a call center.

However, when one or more computer devices that process the queries or which are used by the personnel to process the queries stop functioning, the queries may no longer be efficiently and/or correctly addressed. Queries may be dropped, incorrectly routed, or delayed for an unacceptable period. Users may grow frustrated with the delay and initiate multiple queries for the same request. When this happens, it causes the network and other computational devices to become even more overloaded and/or fail themselves. Further, once systems are back online, the multiple queries may result in duplicate actions being performed, potentially causing additional problems.

One solution to these problems is to provide redundant systems and network capacity. However, redundant systems and network capacity may be expensive, and when not needed, they utilize resources such as power, personnel, and network resources that are not normally needed. Further during large system outages, the redundant systems and network capacity still may not be able to adequately address all the queries.

The system and method disclosed in the present application provide a technical solution to the technical problems discussed above by providing the capability to continue to process queries efficiently when a back-end system or other system or resource needed to process the queries is no longer functioning. By using artificial intelligence (AI) to analyze the queries and request additional information from the user/external device, the system, and method may be able to better gather information needed to process the query later when the back-end systems are back online. This allows a user/external device to no longer need to wait in a queue for the systems to come back online and for the system to efficiently process the queries when the system comes back online without or with a reduced need to contact the user or external device once the system is back online. This reduces the amount of network resources needed to process the queries while the system is offline and reduces the need for redundant systems, increasing efficiency and providing the user with a better experience.

The disclosed system and method are configured to receive a current query from a first device and identify a query type from a plurality of stored query types. The system then obtains, from the first device, the information needed to respond to the current query when a second device(s) and/or resource(s) that normally processes the query are determined not to be functioning normally. When obtaining the information, the system executes an algorithm associated with a text generation model, such as but not limited to a generative artificial intelligence (AI) model, to generate prompts to obtain the information needed to respond to the current query and send them to the first device. In response, the system receives the information, creates an incident ticket, and stores the information with the incident ticket.

When the second device and/or resources are functioning normally again, the system causes the second device and/or resources to perform the actions to process the current query, and the incident ticket is closed when all the actions are performed. When more than one query has been received, the system and method may utilize machine learning to analyze the queries and rank them based on their priority and other pertinent criteria. This allows the system and method to continue receiving queries even when the device(s) or resource(s) to respond to the query are not functioning. It efficiently processes them without requiring additional information when the device or resources are restored.

The system and method disclosed in the present application include a processor operably coupled to a memory configured to store query information for each of a plurality of query types. The query information comprises a list of information needed to respond to a current query and actions to respond to each of the plurality of query types. The memory is also configured to store a text generation model trained on one or more previous queries. The memory may also store a plurality of incident tickets. Each of the incident tickets includes an indication of actions that are to respond to a query type.

The processor receives a current query that includes initial information from a first external device. Using the initial information, the processor may identify a query type from the plurality of query types by comparing the initial information with the query information for each of the plurality of query types. Once the processor identifies the query type, it determines if a second external device that is configured to perform one or more actions associated with the query type is functioning normally. When the second external device is not functioning normally, the processor obtains information from the first external device needed to respond to the current query and produce an incident ticket when the second external device is determined not to be functioning normally.

When obtaining the information from the first external device, the processor executes an algorithm associated with the text generation model to generate one or more prompts. The text generation model determines the one or more prompts to be able to obtain the information needed to respond to the current query. Once the one or more prompts are generated, they are sent to the first external device to obtain the information. In response, the processor receives the information needed to respond to the current query from the first external device and creates an incident ticket associated with the current query. The processor stores the incident ticket in the memory, with the plurality of incident tickets. The incident ticket stored in the memory includes an indication of the actions associated with the identified query type. The information obtained from the first external device is also stored in the memory with the incident ticket.

When the processor determines that the second external device is able to perform the actions, it recalls the incident ticket from the memory. The processor then causes the second external device to perform the actions using the stored information. Once the actions are completed, the processor then may close the incident ticket stored in the memory.

The disclosed system provides several practical applications, such as efficient processing of queries when one or more computing devices or resources needed to process the queries are no longer functioning. Waiting in the queue unnecessarily wastes network and computing resources both for the organization providing the resources and for the user that may be waiting on hold or having their personal user device maintain a connection, web pages, or other applications needed for the query. By gathering the information using AI and storing it with an incident ticket for later processing, a particular query no longer needs to wait in a queue until the system is restored or the query is processed by other means. The disclosed system and method result in a robust network with fewer failures and bottlenecks. Further, by efficiently handling the queries when the system is down, less redundant capacity and resources are needed, reducing both financial and environmental costs.

Certain embodiments of the present disclosure may include some, all, or none of these advantages. These advantages and other features will be more clearly understood from the following drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system configured to use an AI-powered queue resolver during outages;

FIG. 2 illustrates one embodiment of operations performed for resolving queues during an outage; and

FIG. 3 illustrates one embodiment of a flowchart for using an AI-powered queue resolver during outages.

### DETAILED DESCRIPTION

As described above, conventional solutions for handling and processing user queries are insufficient when the external devices and/or applications needed for handling and processing those queries are not functioning normally. This may occur, for example, when one or more external devices that host resources or applications needed to provide information to a user or resource to an application on a user's device stops functioning. In another example, this may occur when resources or information used by a user or user device become corrupted due to coding errors or the results of attacks by bad actors.

When devices or applications needed for providing a resource to external devices and/or users are not functioning normally or not functioning at all, an organization may receive many queries for the correction of data or the performance of other actions that are needed as a result of the malfunction of the devices or applications. While the organization's normal system for handling queries, such as a call center, may be sufficient when only a few users are impacted, the normal system may no longer be adequate when a larger number is impacted. As more and more user devices or other external devices are used to make queries, the systems, such as but not limited to call centers, chat boxes, and automated systems, that an organization uses to respond to queries may become overloaded. This may result in even more technical issues for the organizations as well as potential loss of the users’ willingness to use the affected devices or applications, and/or patronage of the organization may be lost.

When the devices or applications are repaired because calls or queries have been incorrectly routed or dropped, there may be no record of the queries that were incorrectly routed or dropped. There is currently no efficient way to determine which users have sent queries during a large outage since many of the queries may have been incorrectly routed or dropped with no record made. This may result in the query system continuing to be overloaded by users sending queries that have already been addressed or the need to reach out to users that were not affected. Users may not know that they can use the system normally again, or where user input is needed, critical information or actions may not be performed as there is no knowledge of who was affected or pertinent information provided. This results in the organization having to use even more resources to identify which users were affected and to make the appropriate corrections or contacts. This may result in the organization’s reputation being unnecessarily adversely affected.

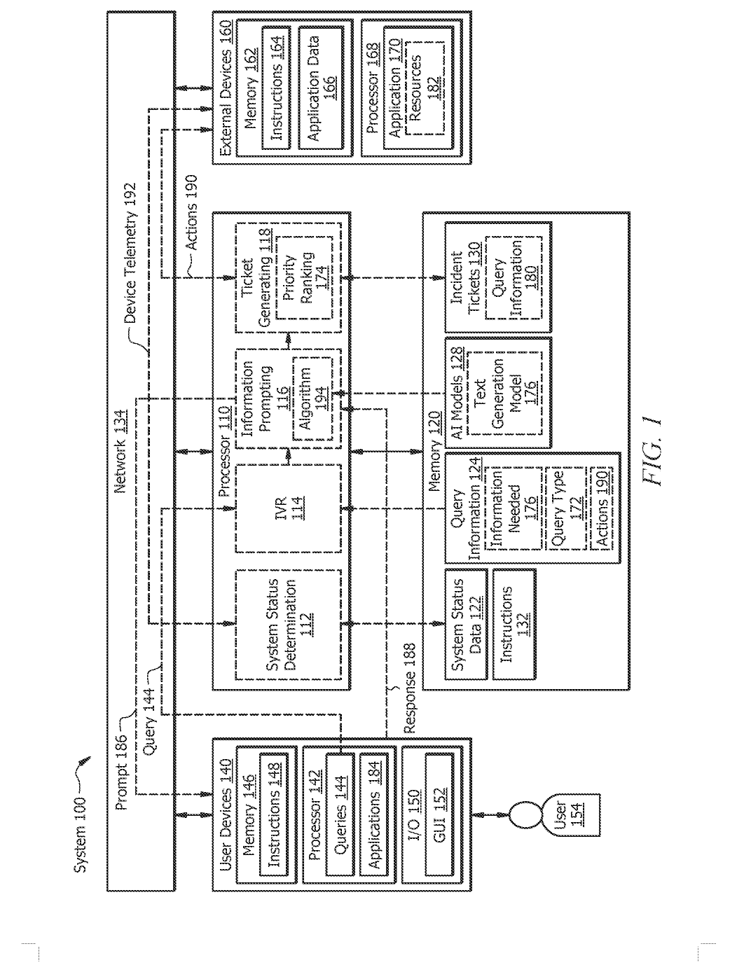

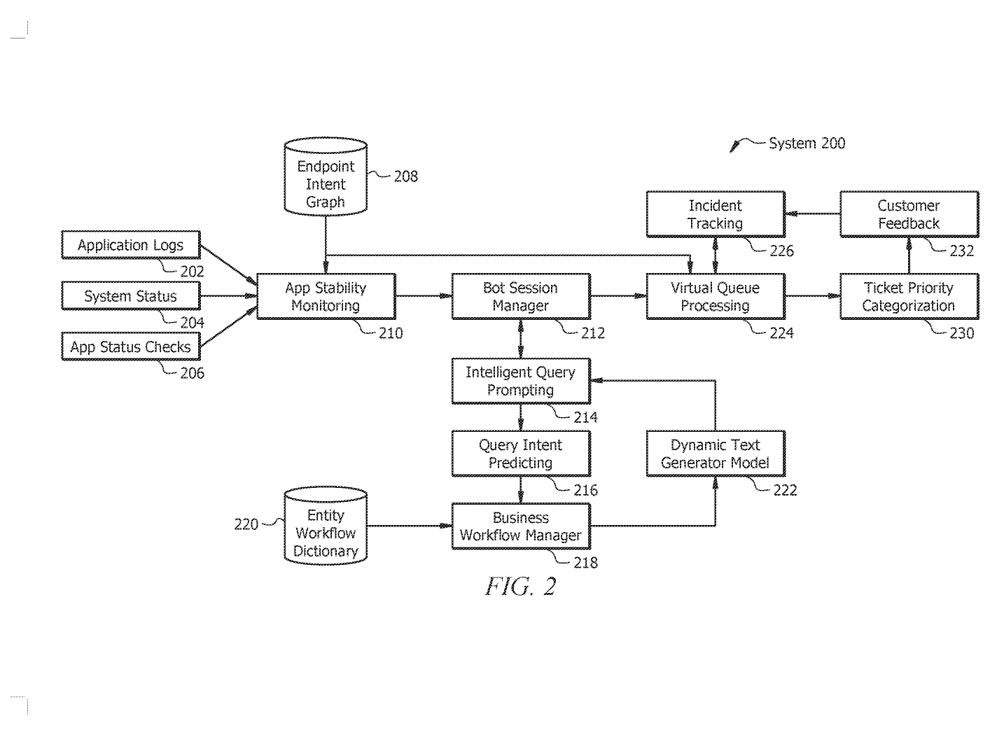

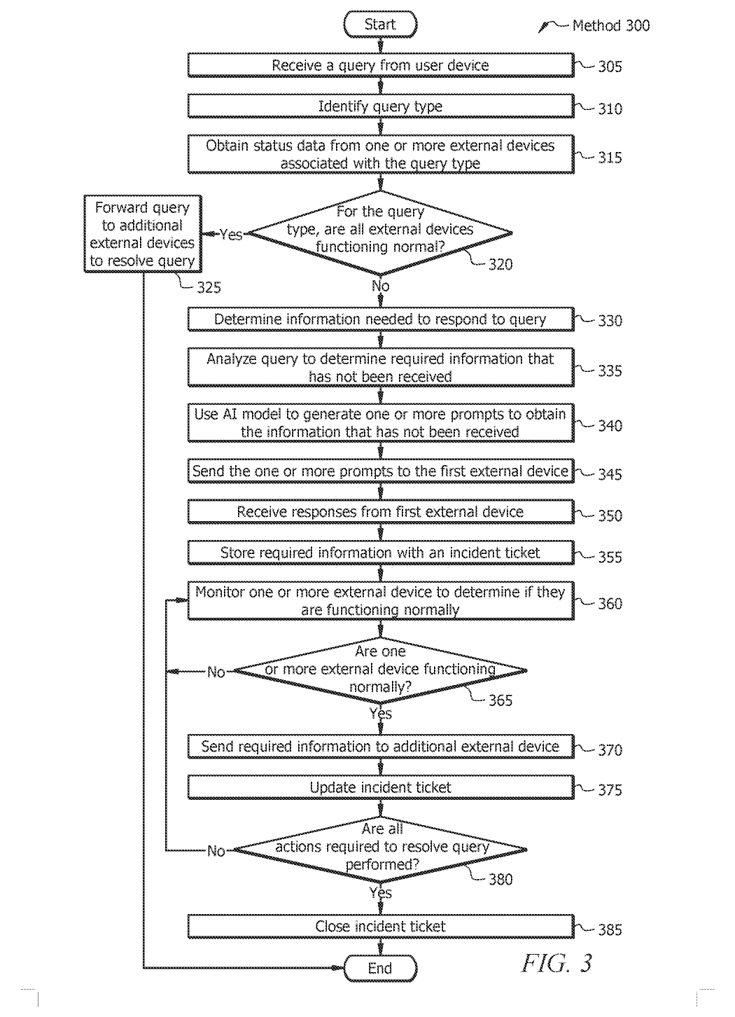

One or more embodiments of this disclosure provide a system and method that utilizes an AI-powered queue resolver to handle user queries. The one or more embodiments allow for the queries to be electronically addressed using AI to collect needed information, including user information as well as problem-specific information that then may be recorded and used at a later time to resolve the query when the pertinent system is operating normally. The system receives the query, classifies it, requests any additional information needed using an AI, and produces a ticket that is tracked until the query is resolved. By using the system and method, queries may be quickly addressed and removed from the queue, freeing up network capacity and computer resources needed to maintain the query in the queue while still ensuring that the query is ultimately addressed and resolved, and potentially less user irritation. Embodiments of the disclosure and its advantages may be understood by referring to FIG. 1, FIG. 2, and FIG. 3.

### System, Overview

FIG. 1 is a schematic diagram of a system 100 configured for electronically receiving queries 144 from one or more user devices 140 that require one or more resources 182 associated with one or more external devices 160 and/or applications 170. More specifically, system 100 is configured to receive a query 144 from a user device 140, make a system status determination 112, and when it determines that the required one or more resources 182 for resolving the query are not functioning and/or available, uses AI to interact with the user device 140 and retrieve information needed 176 for resolving the query 144. Ticket generating 118 is performed, producing incident tickets 130 for each query 144 and is stored in the memory 120 with query information 180 to be used at a later time when the system status determination 112 determines that the external devices 160 and/or applications 170 are available to process the incident ticket 130. The incident tickets 130 may be processed in an order determined based on an assigned priority ranking 174.

In one embodiment, system 100 comprises one or more user devices 140, one or more external devices 160, a network 134, a processor 110, and a memory 120. The processor 110 and memory 120 electronically communicate with the user devices 140 and the external devices 160 through the network 134. The system 100 may be configured as shown or in any other suitable configuration.

### System Components

### Network

The network 134 may be any suitable type of wireless and/or wired network including, but not limited to, all or a portion of the Internet, an intranet, a private network, a public network, a peer-to-peer network, the public switched telephone network, a cellular network, a local area network (LAN), a metropolitan area network (MAN), a wide area network (WAN), and a satellite network. The network 134 may be configured to support any suitable type of communication protocol as would be appreciated by one of ordinary skill in the art.

The network 134 may connect the user devices 140 and external devices 160 with the processor 110 and memory 120. Network 134 may connect the processor 110, memory 120, external devices 160, and user devices 140 through the Internet or other large networks. In one or more embodiments, different elements of system 100 may be at different geographic locations and connected through network 134. While shown as a single network 134, the network 134 may comprise a plurality of components of any suitable networking equipment, including but not limited to routers and switches, that allow at least the user devices 140 and external devices 160 to communicate with the processor 110 and/or memory 120. Network 134 is not limited to the configuration shown in FIG. 1, which is simply shown in this form for simplicity and explanatory purposes.

### External Device

The external devices 160 may include any number of devices that perform one or more applications 170 and/or provide one or more resources 182 to a user device 140. Additionally, the external devices 160 may be one or more systems or devices for resolving customer queries, such as but not limited to units of a call center, help desks, chatbots, and other systems or devices. In one or more embodiments, the external devices 160 may include the one or more user devices 140. Examples of an external device 160 may include but are not limited to, computers, laptops, mobile devices (e.g., smartphones or tablets), servers, clients, automated teller machines (ATM), point of sale devices (POS), or any other suitable type of devices that may be used for accessing or supporting an application 170 and/or providing a resource 182 to the user device 140. While only one external device 160 is shown, in one or more embodiments, a plurality of external devices, e.g., 160, may be present, each hosting an application 170, a plurality of applications, e.g., 170, a resource 182, and/or a plurality of recourses, e.g., 182.

In one or more embodiments, the external device 160 may take the form of a server, data center, cloud device, or any other distributed computing system that hosts an application 170 and/or resources 182 that is used or accessed by the user device 140 performing an application 184 and/or query 144. The application 170 hosted by the external device 160 may be a decentralized application and/or take any other form and may be hosted by more than one external device, e.g., 160. The applications 170 may provide one or more resources 182 and/or perform one or more actions 190 needed to resolve a query 144 or interact with a user device 140. The resources 182 may take any form, such as data stored in the memory 162 of the external device 160 or in one or more databases hosted by one or more other external devices 160. The external device 160 may be associated with the same organization as the processor 110 and/or may be associated with a different organization. The external device 160 may communicate through the network 134 with one or more other external devices, e.g., 160 and/or the user devices 140.

The external device 160 includes at least one processor 168 that performs one or more processes or operations, including performing an application 170 and/or providing a resource 182 to a user device 140. The processor 168 executes instructions 164 stored in the memory 162 to perform the application 170, actions 190, and/or provide the resource 182. The application 170 may include web pages, database applications, banking applications, word processing applications, entertainment applications, video applications, and/or any other applications that an organization may have hosted by the external device 160. The application 170 may provide one or more resources 182 to the user device 140 such as, but not limited to, account information, user 154 information, and/or any other information that may be useful to the user 154. The application 170 may instead respond to a query 144 and perform one or more actions 190 to resolve the query 144, including, for example, connecting a user 154 through their user device 140 to a human representative when necessary to resolve a query 144.

When executing the application 170, the processor 168 may perform various operations. The processor 168 may make API calls, perform batch jobs, modify application data 166 stored in memory 162, modify the resources 182, and modify application data, e.g.,166, stored in other external devices (not shown). The processor may also perform one or more mathematical and logical operations, start and/or maintain active threads, and send and/or receive data or other information through and from the network 134. The processor 168 may perform other operations not listed above without departing from the disclosure; those listed are provided only as examples.

The external device 160 may include a memory 162 for storing instructions 164 for performing the application 170 and/or providing the resource(s) 182 to the user device 140. The memory 162 may also include application data 166 for the application 170. In one or more embodiments, the memory 162 may also store the resources 182, or they may be provided from a database or other device connected to the external device 160 through the network 134.

The memory 162 may be any type of storage for storing instructions 164 for executing by the processor 168, as well as application data 166 used by and/or produced by the application 170 and/or the resources 182. The memory 162 may be a non-transitory computer-readable medium in operative communication with the processor 168. The memory 162 may be one or more disks, tape drives, or solid-state drives. Alternatively, or in addition, the memory 162 may be one or more cloud storage devices. The memory 162 may be volatile or non-volatile. It may comprise read-only memory (ROM), random-access memory (RAM), ternary content-addressable memory (TCAM), dynamic random-access memory (DRAM), and static random-access memory (SRAM).

While FIG. 1 shows the external device 160, including only a single processor 168 and a memory 162, they may include any suitable number and combination of processors, e.g., 168 and memories 162, as well as any other necessary components. For simplicity, only one processor, e.g., 168, and one memory, e.g., 162, are shown in FIG. 1.

### User Devices

The user device(s) 140 may include any number of devices that communicate through the network 134 with the processor 110 and/or external devices 160. The user device 140, in general, is associated with user 154. The user device(s) 140 in one or more embodiments are configured to allow a user 154 to submit a query 144, which, as will be described in more detail below, is processed by the processor 110. The user device(s) 140 may perform other activities and have other components than those shown without departing from the disclosure. In one or more embodiments, the user device(s) 140 may also perform one or more applications 184. However, the user device(s) 140, in one or more embodiments, may simply be a device, for example, a telephone, that is configured to generally only be able to perform a query 144, such as a voice telephone call. While the user device 140 is shown as being separate or different from the external device 160, it may take the same form or be an additional external device 160, with the user device 140 being referred to as the first external device and the external devices 160 may be referred to as a second external device or additional external devices. The disclosure is not limited by the specific nomenclature used above for the user device 140 and external device 160.

Examples of a user device 140 may include but are not limited to, telephones, computers, laptops, mobile devices (e.g., smartphones or tablets), servers, clients, automated teller machines (ATM), point of sale devices (POS), or any other suitable type of devices that may be used for accessing or supporting an application 184 or making a query 144. In one or more embodiments, the user device 140 may take the form of a wearable device such as, but not limited to, a smartwatch, augmented reality eyewear, or other wearable smart devices. User device 140 is not limited to a device used by a user 154 and may be any external device, e.g., 160, that would facilitate making a query 144.

While only one user device 140 is shown, in one or more embodiments, a plurality of user devices, e.g., 140, may be present, each hosting one or more applications 184 and performing one or more queries 144 that allow a user 154 or a plurality of users, e.g., 154 to make a query 144 about or for a resource 182 provided by one or more external devices 160.

The user device 140 includes at least one processor 142 that performs one or more processes or operations, including making queries 144 and performing applications 184. The processor 142 executes instructions 148 stored in the memory 146 to make the query 144 and/or perform the application 184. The applications 184 may include telephony, communication, virtual reality, web pages, database applications, banking applications, word processing applications, entertainment applications, video applications, and/or any other applications that an organization may have hosted by the user device 140. The applications 184 may perform one or more actions that interact with a user 154, for example, allowing the user 154 to enter data, check account balances, and perform other interactions with the applications 184 and the resources 182 hosted by the external devices 160. The applications 184 may also interact with the processor 110 or external device 160 to provide the information needed 176 for the query 144, receive periodic updates (not shown) from the processor 110 regarding an incident ticket 130, or receive data from the processor 110 or external device 160, such as database data.

When executing the applications 184 and/or making queries 144, the processor 142 may perform various operations. The processor 142 may perform actions such as making application programming interface (API) calls, performing batch jobs, modifying application data, and modifying application data 166 stored in other external devices 160. The processor 142 may also perform one or more mathematical and logical operations, start and/or maintain active threads, and send and/or receive data or other information through and from the network 134. The processor 142 may perform other operations not listed above without departing from the disclosure; those listed are provided only as examples.

The processor 142 may work with an input/output (I/O) device 150 in one or more embodiments. The I/O device 150 allows a user 154 to interact with the user device 140. For example, the I/O device 150 may include a touch screen (not shown) or a monitor (not shown) that displays a GUI 152 that the user 154 may interact with through touch or through peripheral devices such as, but not limited to, keyboards, mice, haptic interfaces, or others. The I/O device 150 may include a speaker and microphone in one or more embodiments. For example, if the user device 140 is a telephone, the I/O device 150 may only include a speaker and a microphone and may not include a GUI 152. In another example, the user device 140 may take the form of an ATM machine and not include a speaker and/or a microphone. The I/O device 150 may take the form of any device or combination of devices that allow a user 154 to interact or use the user device 140, and the disclosure is not limited to an I/O device 150 that is just a GUI 152 or other devices previously described. For example, when the user device 140 is a smartphone, it may include a speaker, a microphone, and a touch screen that displays a GUI 152.

The user device 140 may include a memory 146 for storing instructions 148 for performing the applications 184 and/or making queries 144. The memory 146 may store any other data needed to operate the user device 140 properly. The memory 146 may be any type of storage for storing instructions 148 for executing by the processor 142. The memory 146 may be a non-transitory computer-readable medium in operative communication with the processor 142. The memory 146 may be one or more disks, tape drives, or solid-state drives. Alternatively, or in addition, the memory 146 may be one or more cloud storage devices. The memory 146 may be volatile or non-volatile. It may comprise read-only memory (ROM), random-access memory (RAM), ternary content-addressable memory (TCAM), dynamic random-access memory (DRAM), and static random-access memory (SRAM).

When the user or application 184 makes a query 144, processor 142, using instructions 148 stored in memory 146, sends the query 144 through the network 134 to the processor 110. This may be done, for example, when a user 154 or an application 184 encounters a problem with an application 170 or a resource 182 hosted by an external device 160, such as for example, in a non-limiting example, when an account or information that a user 154 needs is not available. Alternatively, the query may be made by the processor 142 when a user 154 or application 184 is simply making a routine query 144, for example, in a non-limiting example, checking an account balance. The user 154 or application 184 utilizes the user device 140 to send the query 144 to the processor 110 to have an external device 160 (such as, but not limited to, a call center) to correct or resolve the problem and/or provide the desired resource 182. When the necessary external devices 160 are not functioning normally, the processor 110 causes the user device 140 to prompt 186, the user 154, or application 184 to provide any additional information needed 176, for example, through the GUI 152. The processor 142 then communicates that information electronically back to the processor 110 for further processing, as will be described in more detail below.

While FIG. 1 shows the user device 140, which includes only a single processor 142 and a memory 146, it may include any suitable number and combination of processors, e.g., 142 and memories 146, as well as any other necessary components. For simplicity, only one processor, e.g., 142, and one memory, e.g., 146, are shown in FIG. 1.

### Processor and Memory

The processor 110 may take the form of any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 110 may be a programmable logic device, a microcontroller, a microprocessor, or any suitable combination of the preceding. The processor 110 is communicatively coupled to and in signal communication with the memory 120. The one or more processors making up the processor 110 are configured to process data and may be implemented in hardware or software. For example, the processor 110 may be 8-bit, 16-bit, 32-bit, 64-bit, or of any other suitable architecture. The processor 110 may include an arithmetic logic unit (ALU) for performing arithmetic and logic operations, processor registers that supply operands to the ALU and store the results of ALU operations, and a control unit that fetches instructions 132 from memory 120 and executes them by directing the coordinated operations of the ALU, registers and other components.

The processor 110 is in operative communication with memory 120 and configured to implement various instructions 132 stored in memory 120. The processor 110 may be a special-purpose computer designed to implement the instructions 132 and/or functions disclosed herein. For example, the processor 110 may be configured to perform operations, including those described below and shown in FIGS. 2 and 3.

Memory 120 may be any type of storage for storing a computer program comprising instructions 132, as well as system status data 122, query information 124, AI models 128, and incident tickets 130. The memory 120 may be a non-transitory computer-readable medium in operative communication with the processor 110. The memory 120 may be one or more disks, tape drives, or solid-state drives. Alternatively, or in addition, the memory 120 may be one or more cloud storage devices. The memory 120 may be volatile or non-volatile. It may comprise read-only memory (ROM), random-access memory (RAM), ternary content-addressable memory (TCAM), dynamic random-access memory (DRAM), and static random-access memory (SRAM).

The memory 120 stores instructions 132, which, when executed by the processor 110, causes the processor 110 to perform the operations shown in FIGS. 1-3 described below. Instructions 132 may comprise any suitable set of instructions, logic, rules, or code. Memory 120 may include storage that may take the form of a database for storing things such as system status data 122, query information 124, artificial intelligence AI models 128, and incident tickets 130. These may be stored and recalled using known protocols such as SQL, XML, and/or any other protocol or language that a user, administrator, or developer of the system 100 wishes to use. The instructions 132, system status data 122, query information 124, AI models 128, incident tickets 130, and any other information stored in memory 120 may be stored in different forms, and the disclosure is not limited to storing the instructions 132, system status data 122, query information 124, AI models 128, and incident tickets 130 as a database.

The memory 120 in one or more embodiments stores system status data 122. The system status data 122 is obtained by the processor 110 performing a system status determination 112. When performing system status determination 112, the processor 110 receives telemetry 192 and other information from the external devices 160, including application logs for the applications 170 and/or resources 182, management data for the external devices 160, as well as application status and/or checks. The processor 110 stores system status data 122 in the memory 120 for each of the external devices 160, applications, and/or resources 182. This system status data 122 then may be used by the processor 110 when a query 144 is received from a user device 140 to determine how the query 144 should be handled, for example, if the external devices 160 and applications 170 needed to perform actions 190 to resolve the query 144 are functioning normally, the query 144 may be simply forwarded to the appropriate external device without further processing by the processor 110 or minimal processing by the processor 110. However, if an outage occurs or other problems arise, such as an external device 160 receiving a number of queries 144 that is greater than a predetermined threshold, additional steps described below may be performed by the processor 110 to resolve query 144. For example, after an outage, the external device 160 that directs calls to the appropriate call center may receive many more calls than it usually does if this is greater than a predetermined threshold determined by an administrator or the organization associated with the external device 160, the processor 110 may determine that additional processing is needed to resolve the query 144 as described below.

The memory 120 in one or more embodiments also stores query information 124. The query information 124 includes the information needed 176 to resolve various query types 172 as well as a list of actions 190 that need to be performed to resolve the queries, e.g., 144. The processor 110 uses the query information 124 to first categorize the query 144 and then determine the information needed 176 for the particular query type, e.g., 172 corresponding to the query 144 received. In one or more embodiments where the query 144 is from a user 154 using their voice, for example, in a non-limiting example, calling a help number or vocally interacting with an application, initial information needed 176 is obtained by the processor 110 or an external device 160 performing an interactive voice response (IVR) operation 114. The IVR operation 114 asks simple questions through the I/O device 150 of the user device 140 to identify the type of query the user 154 is making. For example, if the user 154 is asking for a balance, the user may say “incorrect balance,” and processor 110 would then know the query type 172 is an “incorrect balance” type. If user 154 said “customer representative,” then the processor 110 would know the user wants to speak to a customer representative, and the query type 172 may be a “customer representative” type. The processor 110 may, in response, make additional prompts 186 of the user 154 to determine why they want to speak to the customer representative based on common query types 172 that are often made. Alternatively, when the query is text-based or performed using an application 184 on the user device 140, the processor may be able to classify and determine the query type 172 based on information determined from the text, and an IVR operation 114 is not performed.

Once the query is type 172 is determined, the processor 110 determines from the query information 124 stored in the memory 120 the information needed 176 and the actions 190 that need to be taken to resolve the query. The processor 110 then performs information prompting 116 using an algorithm 194 associated with one or more trained AI models 128 trained on previous queries that were successfully resolved. The information needed 176 may be, but not limited to, account numbers, names, times, dates, particular actions, preferences, and/or any other information that has been determined to be needed to resolve a particular query type 172 successfully.

In one or more embodiments, the processor 110 may use a text generation model 178, such as, but not limited to, generative AI, to produce text or speech that has a high probability of causing the user 154 through the user device 140 to provide the information needed 176. The processor 110 may review the information obtained by the IVR operation 114 or other operations and determine what additional information may be needed 176. The received information will be analyzed, and any additional information needed 176 will be determined. Based on this determination, the processor 110 will create a prompt 186 using an algorithm 194 associated with the AI model 128. The algorithm 194 creates a prompt 186, which has a high probability of soliciting the information needed 176. The processor 110 will then electronically send the prompt(s) 186 through the network 134 to the processor 142 of the user device 140, and the processor 110 will then receive the responses 188 from the user device 140 and/or user 154.

Once the response 188 is received from the user device 140, the processor 110 will analyze the information included in the response 188 and determine if more information is needed. If more information is required, the processor 110 will create and electronically send through the network 134 additional prompts 186. Once all of the information needed 176 is received, the processor 110 then performs ticket generation 118 and stores the query 144 as an incident ticket 130 in memory 120. The incident tickets 130 may include both the ticket, which is used to track each action 190 that needs to be performed in order to resolve the query 144, as well as the information received during the information prompting 116 and/or IVR operation 114 by the processor 110. The incident ticket 130 is then stored in the memory 120 until the processor 110 performing system status determination 112 determines that the external devices 160 and/or their applications 170 and resources 182 are fully functional.

Once the processor 110 determines that the external devices 160 and/or its resources 182 and applications 170 are fully functional, the processor 110 performs priority ranking 174 on the incident tickets 130. This ensures that the most important tickets are resolved first and/or that the incident tickets 130 are resolved in order. This also keeps the external devices 160 from being overwhelmed by trying to resolve all of the incident tickets 130 simultaneously. In one or more embodiments, the priority ranking 174 is performed using a second AI model 128 stored in the memory 120.

This second AI model 128 stored in the memory 120 may have been created by training an AI algorithm on multiple sets of previous queries that were resolved. A user or administrator may classify the queries based on their priority, and then corresponding tickets may be used to train the algorithm in multiple training sets. By using the second AI model 128, the priority ranking 174 of the incident tickets 130 may be performed by the processor 110 with little or no human interaction. Alternatively, this may be performed by other methods, or the incident ticket 130 may be simply processed in the order that they were received. The processor 110 may use any method to perform priority ranking 174 without departing from the disclosure. Once the incident ticket 130 is processed by the external device 160 and/or another entity, the incident ticket 130 is indicated as being closed in the memory 120. This closed incident ticket 130 may be used for training purposes for the AI models 128 or any other purpose.

### Operations performed for resolving queues during an outage

FIG. 2 is a non-limiting example of the operations 200 performed for resolving queries 144 in one or more queues during an outage. The operations 200 are performed by a processor 110 to more efficiently resolve the queries 144 from one or more user devices 140 during an outage of one or more external devices 160 needed to process the queries 144. FIG. 2 is shown as an example of detailed operations for resolving queues during an outage using AI, and the disclosure is not limited to the operations shown in FIG. 2. The example of FIG. 2 may be performed by system 100 described above and as part of the operations performed by the processor 110 as shown in FIG. 1 or may be performed by a different system, e.g., 100, processor, e.g., 110, and/or operations, e.g., 112 than that shown in FIG. 1 without departing from the disclosure.

In the example of FIG. 2, the processor 110, as described above, continuously performs a system status determination 112. The system status determination 112 is performed in one or more embodiments by performing application stability monitoring 210 to monitor telemetry from the applications 170 and/or external devices 160 needed to resolve particular queries. The processor 110, when performing application stability monitoring 210 as part of the system status determination 112, monitors such things as application logs 202, a system status operation 204, and performs application status checks 206 to determine when one or more external devices 160 and/or applications 170 are not functioning appropriately and/or when one or more resources 182 are unavailable or have other problems. This includes determining when the amount of queries 144 or other communications to the external device 160 or their applications 170 is greater than a predetermined threshold that has been selected based on the number of queries or other communications an external device 160 may reasonably process.

In one or more embodiments, the system status operation 204 tracks the status of the various external devices 160, network 134, and/or components thereof. Any outages are noted in the endpoint intent graph 208, which may be stored along with the application logs 202 and other information, such as system status data 122 in memory 120. When possible, the system status operation 204 may route queries 144 and resources 182 to one or more alternative nodes or pathways indicated in the endpoint intent graph that are still functioning; however, when they are not functioning properly or are overloaded, processor 110 may determine to perform the operations described below and with regards to FIG. 3

In one or more embodiments, the processor 110 performing application status checks 206 monitors the status of the applications 170 and/or resources 182 provided by the external devices 160. This, combined with the application logs 202 and the system status operation 204, is used during application stability monitoring 210 to update the endpoint intent graph 208, allowing the processor 110 to make appropriate decisions regarding how to route queries 144 and/or other requests received through the network 134.

When the processor 110, performing application stability monitoring 210 as part of the system status determination 112 determines that an outage is occurring and receives one or more queries 144, the processor may perform optional IVR operation 114 and then information prompting 116 to classify and collect the information needed 176 to respond to the query 144. The processor 110 performing information prompting 116 creates a bot session manager 212 to determine the information needed 176 and to obtain it through prompting 186 of the user device 140 and/or user 154. The bot session manager 212 creates a session for each query 144, which ultimately becomes an incident ticket 130. Based on any initial prompting that may have been performed, the processor 110, using an intelligent query prompting 214 and/or IVR operation 114, may begin classifying the query 144 received in a particular session from the initial responses 188 received from the user device 140. The processor 110 performs query intent prediction 216 to determine what information is included in the initial responses 188 as well as subsequent responses 188 to prompts 186 sent to the user device 140 through the network 134. The processor 110 may use large language models or other techniques to perform the query intent prediction 216.

The processor 110 takes the results of the query intent prediction and analyzes them with a business workflow manager operation 218. The business workflow manager operation 218 uses information obtained from the entity workflow dictionary 220 to classify the query 144 as well as determine the information needed 176. The entity workflow dictionary 220, in one or more embodiments, may be a database stored in the query information 124 of the memory 120. The entity workflow dictionary 220 may include keywords that may be included in the query 144 and used to determine query types 172. The query types 172 may be associated with the information needed 176 for each query type 172.

From the intent prediction 216 and information needed 176 obtained from the entity workflow dictionary 220, the processor 110 performing the business workflow manager operation 218, produces initial prompts for the dynamic text generator model 222 to use to develop prompts 186 that have a high probability of obtaining the information needed 176. The processor 110, when performing the business workflow manager operation 218, manages the dynamic text generator model 222 to produce prompts 186, which the processor sends through intelligent query prompting 214 to the user device 140. Operations 214-222 may be repeated until all of the information needed 176 for a particular query type 172 corresponding to the query 144 is received by the processor 110.

In one or more embodiments, the processor 110 uses a dynamic text generator model 222 to produce prompts 186 that have a high probability of obtaining the information needed 176. The dynamic text generator model 222, in one or more embodiments, may take the form of generative AI. However, the dynamic text generator model 222 may be any AI model 128 that is stored in memory 120 and able to produce intelligent prompts 186. The processor 110 uses the dynamic text generator model 222 to develop the prompts 186 sent to the user device 140 based on information provided by the business workflow manager operation 218 detailing what additional information is needed based on information stored in the entity workflow dictionary 220, which may be part of the query information 124 stored in memory 120. Once the processor 110, using the dynamic text generator model 222, produces the prompt 186, the intelligent query prompter 214 sends the prompt 186 to the user device 140 and receives a response 188 back from the user device 140. This response 188 is then analyzed by the processor 110 performing a query intent prediction 216 to determine what information was received; the business workflow manager operation 218 determines if all the information needed 176 has been received; if not, operations 222-218 are repeated until all information needed 176 is received. Once the processor 110 performs the business workflow manager operation 218 and determines that all the information needed 176 has been received, the bot session manager 212 ends the session with the user device 140, and the processor 110 begins ticket generating 118.

During ticket generating 118, the processor 110 produces an incident ticket 130 and saves it along with query information 180 in the memory 120. The processor also performs in-memory virtual queue processing 224 and incident tracking 226. When performing incident tracking 226, the processor 110 monitors each of the incident tickets 130 and tracks them until they are resolved. When the appropriate external device 160 and/or its applications 170 or resources 182 become available, the in memory virtual queue processing 224 uses a ticket priority categorization operation 230 to determine the priority for addressing each incident ticket 130.

In one or more embodiments, the processor 110, when performing the priority categorization operation 230, uses a trained AI model 128 to determine the priority of each incident ticket 130. Alternatively, the incident tickets 130 may be acted on in the order that they were received or in some other predetermined order. When using the trained AI model 128, the processor 110 is able to prioritize the incident tickets 130 not just based on the order they are received but also the query types 172 that are associated with them. For example, in a non-limiting example, a query 144 to receive account information may have a lower priority than a query 144 that is directed to a potential attack by a bad actor on a user’s 154 account.

Once the incident tickets 130 are prioritized by the processor performing priority categorization operation 230, the virtual queue processing 224 then causes the appropriate external device(s) 160 to perform the actions 190 needed to resolve the query 144. When the incident tracker 226 determines that the query 144 associated with a particular incident ticket 130 has been resolved, the processor 110 may perform optional customer feedback 232. This customer feedback 232 may be used to further train the AI models 128 as well as ensure that the incident tickets 130 were properly resolved.

### Process for using an AI-powered queue resolver during outages

FIG. 3 is a flowchart of an embodiment of method 300 performed by a processor 110 for using an AI-powered queue resolver during outages. The processor 110 may execute instructions 132 stored in the memory 120, which employs method 300 for handling queries 144 received from one or more user devices 140 during outages of one or more external devices 160 needed to resolve those queries 144.

Method 300 begins at operation 305 when processor 110 electronically receives a query 144 through the network 134 from a user device 140. The query 144 may take the form of a voice interaction or text-based interaction between the user 154 and external device(s) 160 for resolving one or more issues or problems the user 154 may have with applications 170 or resources 182 provided by the one or more external devices(s) 160 which may or may not include the same external device 160 that the query 144 is directed to. For example, in a non-limiting example, where query 144 is a voice interaction, the query 144 may be directed to a call center while a separate external device, e.g., 160, may be needed to provide a resource 182, such as user information. Where the query 144 is in the form of a text query 144, it may be directed towards an application 170 in the form of a chatbot or other interactive text system. The query 144 may take any form, and the disclosure is not limited to voice and text queries.

From the query 144, the processor 110 then identifies the query type 172 in operation 310. The query type 172 may be determined by an optional IVR operation 114 or other similar operations performed by the processor 110 to determine a query type 172 initially. Based on the determined query type 172, the processor 110 then obtains system status data 122 from one or more external devices 160 associated with the query type 172 in operation 315. The system status data 122 may include information related to the applications 170, resources 182, and or electronic components of the external devices 160. As discussed above, the processor 110 may determine the status in one or more embodiments by analyzing a current endpoint intent graph 208.

Once the system status data 122 is obtained in operation 315, the processor 110 then determines in operation 320 if all the external devices 160 and/or their applications 170 needed for processing the query 144 are functioning normally. If the processor 110 determines they are functioning normally in operation 320, the query 144 is forwarded to the appropriate external devices 160 to resolve the query 144 in operation 325.

Alternatively, if the processor 110 determines in operation 320 that one or more of the external devices 160 and/or their application 170 are not functioning normally, the method 300 then proceeds to operation 330 where the information needed 176 to respond to the query is determined by the processor 110. The processor 110 determines what information is needed 176 by comparing initial information obtained in the query 144 to information stored in the query information 124 of the memory 120. The processor 110 may use a business workflow manager operation 218 combined with an entity workflow dictionary 220 as described above with regards to FIG. 2 to determine the information needed 176, or the processor 110 may perform other operations to determine what information is needed 176 from the query information 124 stored in the memory 120 that is associated with the current query’s 144 query type 172.

The processor 110 analyzes the query 144 to determine the information needed 176 that has not already been received in operation 335. The processor 110 then uses an algorithm 194 associated with the AI model 128 to generate one or more prompts 186 to obtain the information needed 176 that has not already been received in operation 340. In one or more embodiments, the AI model 128 may use a text generation model 178, such as but not limited to generative AI. The processor 110 electronically sends the one or more prompts 186 through the network 134 to the user device 140 in operation 345 and receives responses 188 from the user device 140 in operation 350.

The processor 110 determines what information has been received from the external device. Once all information needed 176 is received, the query information 180 is stored along with an incident ticket 130 in the memory 120 in operation 355. The processor 110 monitors the external devices 160, their applications 170, and/or their resources 182 to determine if they are functioning normally in operation 360. If they are determined in operation 365 to not be functioning normally, the method 300 returns to operation 360, and the processor 110 continues to monitor the external device 160, applications 170, and/or resources 182 until the processor 110 determines in operation 365 that they are functioning normally.

When the processor determines that the external devices 160, applications 170, and/or resources 182 needed for responding to the query 144 in operation 365 are functioning normally in operation 365, the processor 110 then sends the appropriate query information 180 to the external device 160 in operation 370, which performs one or more actions 190 to resolve the ticket. The processor 110 then updates the incident ticket 130 in operation 375 and determines if all actions 190 associated with the query 144 have been performed in operation 380. If they have not, the method 300 returns to operation 360, where the remaining external devices 160, applications 170, and/or resources 182 are monitored, and operations 360-380 are repeated until all actions 190 have been performed. Once all actions 190 associated with the query 144 have been performed, the processor 110 closes the incident ticket 130 in operation 385. The processor may optionally perform customer feedback 232 or other operations once the incident ticket 130 has been closed or perform other operations or actions 190. Once either operation 325 or 385 is completed, method 300 of FIG. 3 ends. In one or more embodiments, operations 305-385 are performed by the processor 110 until all queries 144 are completed, and/or operations 305-385 may be continuously performed without departing from the disclosure.

The present examples are to be considered illustrative and not restrictive, and the intention is not to be limited to the details given herein. For example, the various elements or components may be combined or integrated into another system, or certain features may be omitted or not implemented.

While several embodiments have been provided in the present disclosure, it should be understood that the disclosed systems and methods might be embodied in many other specific forms without departing from the spirit or scope of the present disclosure. The present examples are to be considered illustrative and not restrictive, and the intention is not to be limited to the details given herein. For example, the various elements or components may be combined or integrated into another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office and any readers of any patent issued on this application in interpreting the claims appended hereto, applicants note that they do not intend any of the appended claims to invoke 35 U.S.C. § 140(f) as it exists on the date of filing hereof unless the words “means for” or “operation for” are explicitly used in the particular claim.

1. A system, comprising:
a memory configured to:
store query information for each of a plurality of query types, wherein the query information comprises a list of information needed to respond to a query and actions to respond to each of the plurality of query types;
store a text generation model, wherein the text generation model is trained on one or more previous queries; and
store a plurality of incident tickets wherein each of the plurality of incident tickets comprises an indication of the actions that are needed to respond to a query type identified from the plurality of query types; and
a processor operably coupled to the memory and configured to:
receive the query from a user device, wherein the query comprises initial information;
identify a query type from the plurality of query types, wherein the query type is identified by comparing the initial information with the query information for each of the plurality of query types;
determine if an external device is functioning normally, wherein the external device is configured to perform one or more actions associated with the query type associated with the query; and
obtain, from the user device, information needed to respond to the query to produce an incident ticket when the external device is determined to not be functioning normally;
wherein the processor, when obtaining the information from the user device, is further configured to:
execute an algorithm associated with the text generation model to generate one or more prompts to obtain the information needed to respond to the query;
send the one or more prompts to the user device to obtain the information needed to respond to the query;
receive the information needed to respond to the query from the user device;
create an incident ticket associated with the query, wherein the incident ticket includes an indication of the actions associated with the identified query type;
store the incident ticket with the plurality of incident tickets in the memory;
store the information with the incident ticket in the memory;
cause the external device to perform the actions using the stored information when it is determined that the external device is able to perform the actions; and
close the incident ticket when all the actions are performed.

2. The system of claim 1, further comprising forwarding the query to the external device when the external device is determined to be functioning normally.

3. The system of claim 1, wherein the text generation model is a generative artificial intelligence (AI) model.

4. The system of claim 1, further comprising an additional external device which initially receives a query request from the user device and obtains the query and the initial information from the user device.

5. The system of claim 1, wherein the query type is identified using an integrated voice response (IVR) system.

6. The system of claim 1, further comprising a plurality of queries and a plurality of incident tickets, wherein each incident ticket is associated with one of the plurality of incident tickets, and each incident ticket is assigned a priority ranking for determining when the actions associated with each incident ticket will be performed by the external device.

7. The system of claim 6, wherein the priority ranking is determined by the processor using a trained artificial intelligence (AI) model that is different than the text generation model.

8. The system of claim 1, wherein the external device is a device in a call center.

9. The system of claim 1, wherein the external device is determined to not be functioning normally when an amount of queries received by the external device is greater than a predetermined threshold.

10. A method, comprising:
receiving a query from a user device, wherein the query comprises initial information;
identifying a query type from a plurality of stored query types, wherein the query type is identified by comparing the initial information with query information for each of the plurality of stored query types;
determining if an external device is functioning normally, wherein the external device is configured to perform one or more actions associated with the query type associated with the query;
obtaining, from the user device, information needed to respond to the query when the external device is determined to not be functioning normally;
wherein the obtaining comprises:
executing an algorithm associated with a text generation model to generate one or more prompts to obtain the information needed to respond to the query;
sending the one or more prompts to the user device to obtain the information needed to respond to the query; and
receiving the information needed to respond to the query from the user device;
creating an incident ticket associated with the query when the external device is determined to not be functioning normally, wherein the incident ticket includes an indication of actions associated with the identified query type;
storing the incident ticket in a memory;
storing the information with the incident ticket in the memory;
causing the external device to perform the actions using the stored information, when it is determined that the external device is able to perform the actions; and
closing the incident ticket when all the actions are performed.

11. The method of claim 10, further comprising forwarding the query to the external device when the external device is determined to be functioning normally.

12. The method of claim 10, wherein the text generation model is a generative artificial intelligence (AI) model.

13. The method of claim 10, wherein the receiving is initially performed by an additional external device that receives the query from the user device and obtains the initial information from the user device.

14. The method of claim 10, further comprises:
receiving a plurality of additional queries from a plurality of user devices;
identifying a query type for each of the plurality of additional queries;
obtaining, from the user device, information needed to respond to each of the plurality of additional queries when the external device is determined to not be functioning normally;
creating a plurality of additional incident tickets associated with each of the plurality of additional queries, wherein each of the plurality of additional incident tickets includes an indication of the actions associated with the identified query type;
storing the plurality of additional incident tickets in a memory;
storing the information for each of the plurality of additional queries with the plurality of additional incident tickets in the memory; and
assigning a priority ranking for each of the plurality of additional incident tickets that determines when the actions associated with each of the plurality of additional incident tickets will be performed by the external device.

15. The method of claim 10, wherein the external device is determined to not be functioning normally when an amount of queries received by the external device is greater than a predetermined threshold.

16. A non-transitory computer-readable medium storing instructions that, when executed by a processor, cause the processor to:
receive a query from a user device, wherein the query comprises initial information;
identify a query type from a plurality of stored query types, wherein the query type is identified by comparing the initial information with query information for each of the plurality of stored query types;
determine if an external device is functioning normally, wherein the external device is configured to perform one or more actions associated with the query type associated with the query;
obtain, from the user device, information needed to respond to the query when the external device is determined to not be functioning normally;
wherein the obtaining comprises:
executing an algorithm associated with a text generation model to generate one or more prompts to obtain the information needed to respond to the query;
sending the one or more prompts to the user device to obtain the information needed to respond to the query; and
receiving the information needed to respond to the query from the user device;
create an incident ticket associated with the query when the external device is determined to not be functioning normally, wherein the incident ticket includes an indication of actions associated with the identified query type;
store the incident ticket in a memory;
store the information with the incident ticket in the memory;
cause the external device to perform the actions using the stored information when it is determined that the external device is able to perform the actions; and
close the incident ticket when all the actions are performed.

17. The non-transitory computer-readable medium of claim 16, wherein the instructions further cause the processor to:
forward the query to the external device when the external device is determined to be functioning normally.

18. The non-transitory computer-readable medium of claim 16, wherein the text generation model is a generative artificial intelligence (AI) model.

19. The non-transitory computer-readable medium of claim 16, wherein the receiving is initially performed by an additional external device that receives the query from the user device and obtains the initial information from the user device.

20. The non-transitory computer-readable medium of claim 16, wherein the instructions further cause the processor to:
receive a plurality of additional queries from a plurality of user devices;
identify a query type for each of the plurality of additional queries;
obtain, from the user device, information needed to respond to each of the plurality of additional queries when the external device is determined to not be functioning normally;
create a plurality of additional incident tickets associated with each of the plurality of additional queries, wherein each of the plurality of additional incident tickets includes an indication of the actions associated with the identified query type;
store the plurality of additional incident tickets in a memory;
store the information for each of the plurality of additional queries with the plurality of additional incident tickets in the memory; and
assign a priority ranking for each of the plurality of additional incident tickets that determines when the actions associated with each of the plurality of additional incident tickets will be performed by the external device.
